(19) United States
(12) Patent Application Publication
(10) Pub. No.: US 2009/0017675 A1
(43) Pub. Date: Jan. 15, 2009

(54) STEREO CONNECTOR ASSEMBLY WITH REAR TERMINAL BLOCK

(75) Inventors: Peter R. Daly, Yorktown Heights, NY (US); Christopher J. Poulin, Carmel, NY (US); Gregory Schwartz, Pound Ridge, NY (US)

Correspondence Address: Leason Ellis LLP, 81 Main Street, Suite 100, White Plains, NY, 10601, US

(73) Assignee: BTX Technologies, Inc., Hawthorne, NY (US)

(21) Appl. No.: 11/777,010

(22) Filed: Jul. 12, 2007

(51) Int. Cl. H01R 11/00

(52) U.S. Cl. 439/502

(57) ABSTRACT

In one exemplary embodiment, a miniature stereo jack assembly includes an internal sub-assembly including a printed circuit board, a stereo jack component for receiving a stereo jack, and a terminal block. The stereo jack component is disposed against and in electrical contact with a first surface of the printed circuit board and the terminal block is disposed against and in electrical contact with a second surface of the printed circuit board. The stereo jack assembly also includes a housing that surrounds the internal sub-assembly. The housing has a first portion that has external threads for mating with a fastener that is used to attach the stereo jack assembly to a surface, such as a wall plate, panel, chassis or box.

### TECHNICAL FIELD

The present invention relates generally to an electrical connector and more particularly, a miniature stereo phone jack assembly (e.g., 3.5 millimeter connector) that includes a terminal block rear termination for ease of assembly to wires, a “D” style form-factor for easy mounting and an elongated threaded bushing that allows the connector to be mounted to objects having increased thicknesses.

### BACKGROUND

It is often necessary and desirable to electrically connect one component to another component, especially in the ever expanding world of computers and electronics, especially in multi-media applications and settings. A number of different interfaces can be used depending upon the precise nature of the setting.

More specifically, it is often necessary in the low voltage electronic systems integration industry, such as home theater, broadcasting and audio visual, to interconnect many different devices that create a whole system. A large portion of these devices use 3.5 millimeter stereo (3 conductor) connectors as the external connection medium for stereo audio. This type of connector is common on computers, portable audio equipment, such as MP3 players, and many other devices. Because computers and portable audio equipment are often used interchangeably in situations, such as, conference rooms and class rooms, there is a need to be able to easily connect these devices into a system.

One currently available solution is the “feed-thru” variety of connector, where the same connector is on the front and the back. In this instance, this results in a 3.5 mm stereo jack being provided on the front and a 3.5 mm stereo jack being provided on the back. This is a problem because, out of physical necessity, the connector length is long and the “behind the panel depth” doesn't allow enough room for the mating cable-end connector when mounted in standard electrical junction boxes, surface mount boxes and any types of enclosures.

Another currently available solution is a solder type connector where there are three solder tabs on the back of the connector for fixing wires. This solution is also problematic because soldering in the field is often difficult due to the nature of the location (spatial considerations) to say nothing of providing power to the soldering equipment.

Most panel mounted 3.5 mm solder connectors share a common characteristic, namely, the mounting method. Mounting is achieved by threading the outside of the bushing on the front of the connector and then securing the connector to the panel with a nut. The average threaded bushing only allows the connector to be mounted in a wall plate, panel, chassis or box thickness of only 0.090 inches. With the proliferation of “Designer” wall plates, panels, chassis and boxes, wall thicknesses of up to ⅛ (0.125 inches) are more and more common and there are some that are even thicker. Standard solder type connectors do not have a long enough bushing to accommodate these thicknesses and special fabrication operations are necessary to create counter-bores in these plates in order to fix these connectors to them. This is time consuming and very costly.

For example, FIG. 1 shows a typical chassis mount 3.5 mm stereo jack (with threaded bushing) 10. It is important to realize that the length of the bushing is not equal to the panel thickness that it can be mounted into. This is because a nut must be added to the front and the nut has its own thickness and must be fully engaged on the threads of the bushing 10. FIG. 2 shows a typical “feed-thru” style 3.5 mm stereo jack 20. It is important to note that the behind the panel depth is about 0.823 and therefore, when the jack 20 is coupled with a mating connector, which is necessary in this instance, the behind the panel depth requirements can exceed 2 inches excluding the cable in the mating connector which requires a bend radius.

### SUMMARY

In one exemplary embodiment, a miniature stereo jack assembly includes an internal sub-assembly including a printed circuit board, a stereo jack component for receiving a stereo jack, and a terminal block. The stereo jack component is disposed against and in electrical contact with a first surface of the printed circuit board and the terminal block is disposed against and in electrical contact with a second surface of the printed circuit board. The stereo jack assembly also includes a housing that surrounds the internal sub-assembly. The housing has a first portion that has external threads for mating with a fastener that is used to attach the stereo jack assembly to a surface, such as a wall plate, panel, chassis or box.

In another embodiment, a stereo jack assembly includes an internal sub-assembly including a printed circuit board, a stereo jack component for receiving a stereo jack, and a terminal block. The stereo jack component is disposed against and in electrical contact with a first surface of the printed circuit board. The terminal block is disposed against and in electrical contact with a second surface of the printed circuit board. The terminal block also includes a first part that is supported on the printed circuit board and a second part that is separate from the first part and includes means for receiving and terminating ends of a plurality of first contacts that are to be electrically connected to the circuit board. The assembly further has a housing surrounding at least a portion of the internal sub-assembly. The housing has a first portion that has external threads for mating with a fastener that is used to attach the stereo jack assembly to a surface, such as a wall plate, panel, chassis or box.

### BRIEF DESCRIPTION OF THE DRAWING FIGURES

The foregoing and other features of the present invention will be more readily apparent from the following detailed description and drawings figures of illustrative embodiments of the invention in which:

FIG. 1 is a side elevation view of a conventional chassis mount (with threaded bushing) 3.5 mm stereo jack;

FIG. 2 is a side elevation view of a conventional “feed-thru” style 3.5 mm stereo jack;

FIG. 3 is a rear perspective view of a stereo connector assembly with terminal block termination according to one exemplary embodiment of the present invention;

FIG. 4 is a front perspective view of the connector assembly of FIG. 3;

FIG. 5 is a rear perspective view of the connector assembly of FIG. 3 with a hex nut;

FIG. 6 is a cross-sectional view of the connector assembly of FIG. 5;

FIG. 7 is a front perspective view of internal components of the assembly of FIG. 3;

FIG. 8 is a rear perspective view of the internal components of FIG. 7;

FIG. 9 is a top plan view of the connector assembly of FIG. 5 with a fastener attached thereto;

FIG. 10 is a top plan view of the connector assembly of FIG. 5 without a fastener attached thereto; and

FIG. 11 is an exploded perspective view of a stereo connector assembly with terminal block termination according to another exemplary embodiment of the present invention.

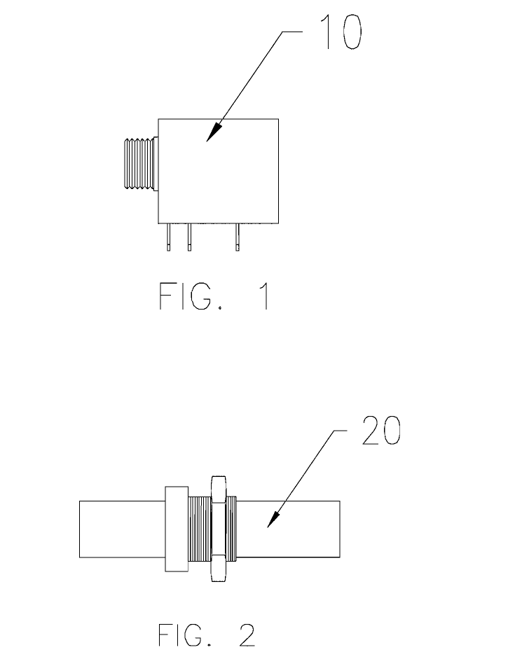

### DETAILED DESCRIPTION OF PREFERRED EMBODIMENTS

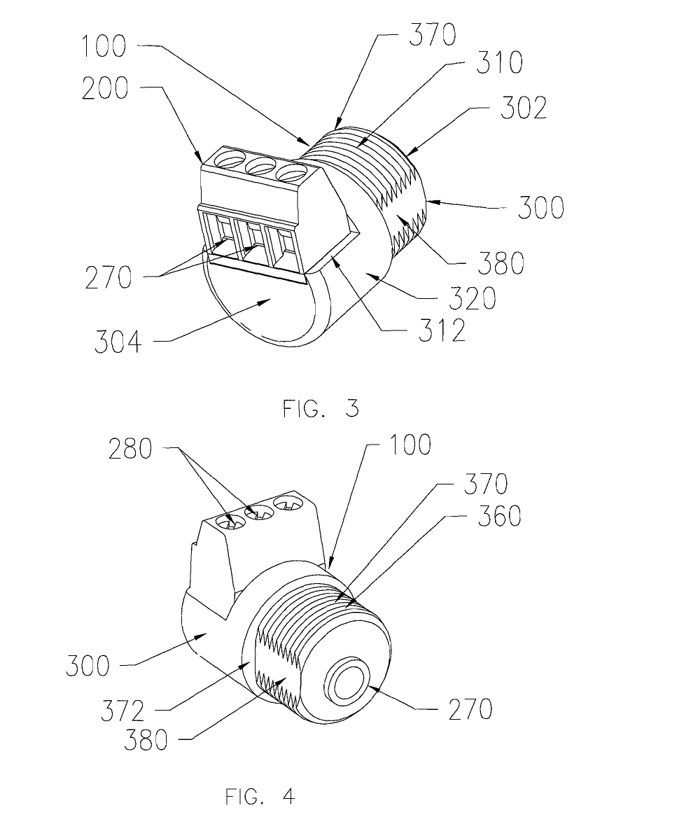

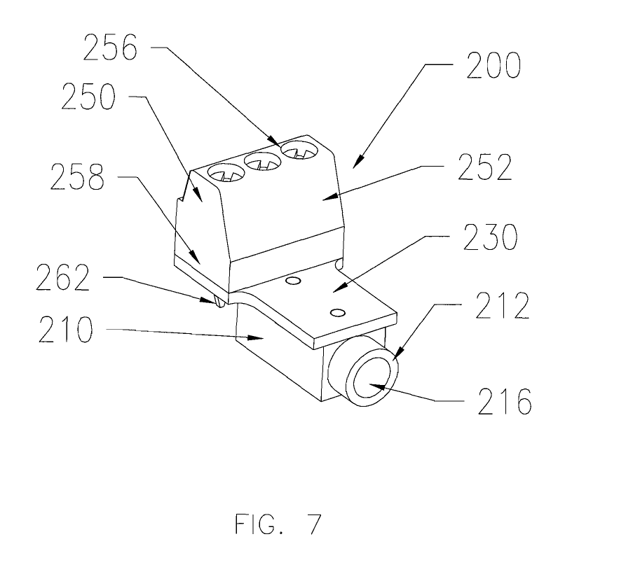

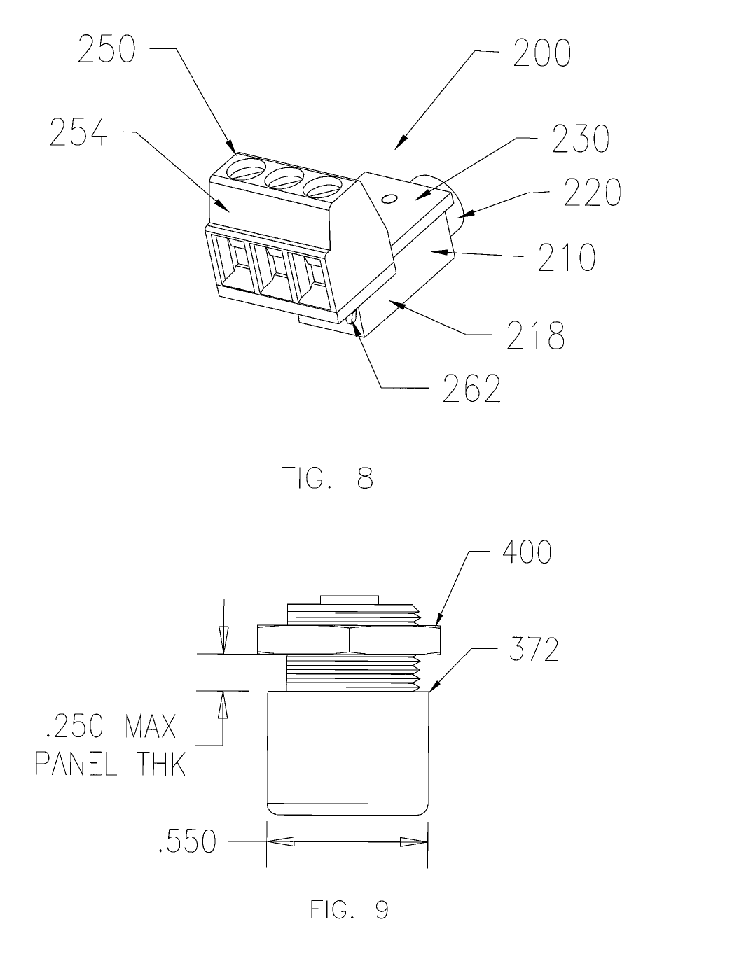

Now referring to FIGS. 3-10, a stereo connector assembly 100 according to a first embodiment of the present invention is illustrated. The connector assembly 100 includes an internal sub-assembly 200 that is best shown in FIGS. 7-8 and a housing 300 that is mated to the internal sub-assembly 200. The internal sub-assembly 200 includes a stereo jack component 210 (e.g., a 3.5 mm stereo jack), a printed circuit board 230 and a terminal block 250 that are coupled to one another to form the sub-assembly 200 illustrated in FIGS. 7-8. The jack component 210 has a first end 212 and an opposing second end 214 with a bore (opening) 216 being formed therein and open at the first end 212. As illustrated in FIG. 8, the jack component 210 can include a main body 218 and a boss portion 220 (e.g., an annular wall) that extends outwardly and beyond the main body 218. The bore 216 is defined by the boss portion 220 and extends inwardly into the main body 218 and has a circular cross-section to receive a conventional stereo jack that is inserted therein. The second end 214 is a closed end.

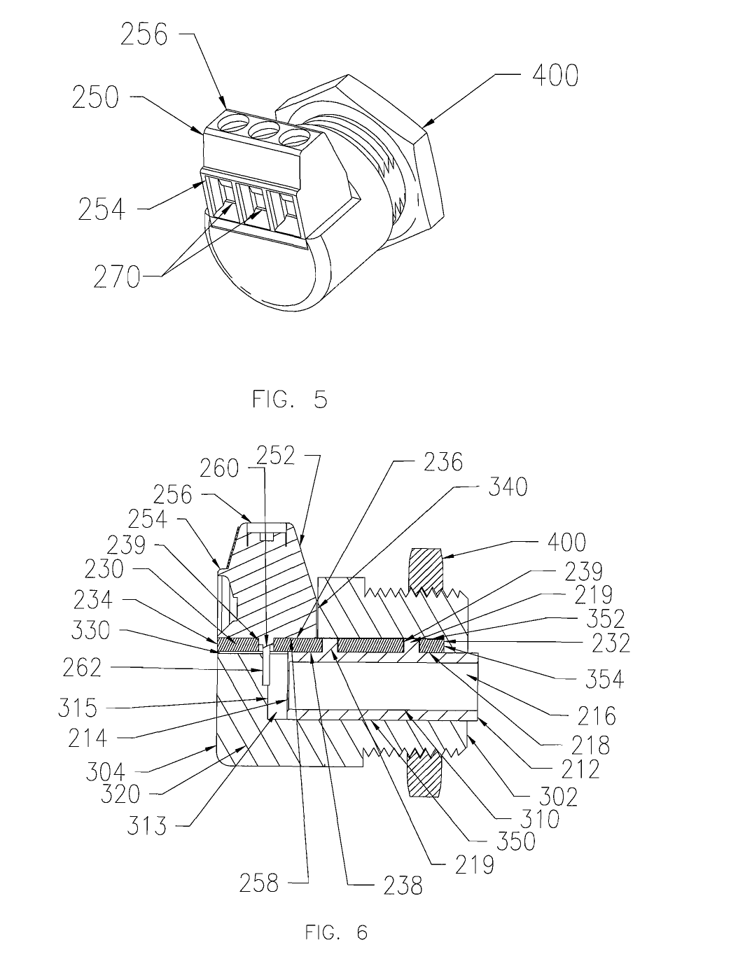

The main body 218 can have any number of different shapes and in the illustrated embodiment, the main body 218 has a square or rectangular shape. The main body 218 includes an upper surface 219 which is configured to be surface mounted to the printed circuit board 230 and therefore is planar so that the printed circuit board 230, described in detail below, can rest thereon. The height of the main body 218 is preferably equal to the diameter of the boss portion 220 as shown in FIG. 6.

The printed circuit board 230 can be in the form of a conventional printed circuit board and includes a first end 232, an opposing second end 234, an upper surface 236, and an opposing lower surface 238. The printed circuit board 230 can have a wafer or plate like construction in that the upper and lower surfaces 236, 238 are planar.

The main body 218 can have first coupling or locating members 219 that are configured to mate with second coupling or locating members 239 that are formed as part of the printed circuit board 230. For example, the first coupling members 219 can be in the form of protrusions or projections (locating pins) that extend outwardly from the upper surface 219 of the main body 218. The first locating members 219 are spaced apart from one another along the upper surface 219. The second coupling members 239 can be in the form of holes or apertures that pass through the printed circuit board 230.

The printed circuit board 230 is positioned on the upper surface 219 of the main body 218 of the jack 210 so that a portion, including the second end 234, extends beyond the second end 214 of the jack component 210 and the fist end 232 rests on the upper surface 219 and is spaced inwardly from the first end 212. In particular, the first end 232 is located at or proximate the interface between the main body 218 and the boss portion 220 (however, other shapes are equally possible). In other words, the boss portion 220 extends beyond the first end 232 of the printed circuit board 230. As shown in FIGS. 7-8, the width of the printed circuit board 230 is greater than the width of the main body 218 and the boss portion 220.

The main body portion 218 is coupled to the printed circuit board 230 by inserting the first locating members 219 into the second locating members 239 so as to couple the printed circuit board 230 to the jack component 210 with the printed circuit board 230 resting on the upper surface 219. This provides a means for properly locating the printed circuit board 230 relative to the jack component 210.

One of the second locating members 239 is formed in a region that extends beyond the jack component 210 and therefore, is not located over the main body 218 of the jack component 210. This second locating member 239 is constructed to couple and locate the printed circuit board 230 relative to the terminal block 250 as described below.

The terminal block 250 is disposed along the upper surface 236 of the printed circuit board 230. The terminal block 250 has a front face 252 and an opposing rear face 254 and an upper surface 256 and opposing lower surface 258. The terminal block 250 is coupled to and located relative to the printed circuit board 230 so that the lower surface 258 seats against the upper surface 236 of the printed circuit board 230. The lower surface 258 includes a third locating member 260 that is configured to mate with one of the second locating members 239 formed in the printed circuit board 230. For example, the third locating member 260 can be in the form of a projection or protrusion that is configured to be received within opening 239 formed in the region of the printed circuit board 230 that extends beyond the main body 218 of the jack component 210. When the third locating member 260 engages the opening 239, the terminal block 250 is supported by the printed circuit board 230.

The terminal block 250 is supported on the printed circuit board 230 with the front face 252 faces boss portion 220 and the opposing rear face 254 is disposed at or proximate the second end 234 of the printed circuit board 230. The terminal block 250 includes a number of contact or terminal openings or slots 270 that are formed along the rear face 254. For example, there can be three contact or terminal openings 270 that receive contacts or conductive member, such as wires, as a means for terminating the wires and provide a means for connecting the terminated wires to another electrical device, such as a connector, in this case the stereo jack component 210.

The terminal block 250 also includes fastening means 280 for engaging the wires inserted into the terminal openings 270 such that the wires are securely held in place within the terminal openings 270. When the wires are securely held in place within the terminal openings 270, the wires are electrically connected to conductive members that themselves are electrically connected to the conductive elements that form a part of the printed circuit board 230 as described below. The fastening means 280, as illustrated, is in the form of individual screws that are in communication with the contact openings 270. For example, each terminal opening 270 has its own fastener (screw) and therefore, after insertion of the wire into the terminal opening 270, the screw for this terminal opening 270 is tightened so as to securely attach the inserted wire to a conductive element of the terminal block 230. Thus, in the embodiment where there are three terminal openings 270, there are three fasteners 280 for engaging the wires inserted into the terminal openings 270.

In addition, the terminal block 250 includes at least one and preferably a plurality of contacts 262 that extend downwardly therefrom for mating with respective contacts of the printed circuit board 230. For example, each terminal opening 270 can have its own associate contact 262. The contact 262 can be in the form of an elongated pin or finger that passes through the opening 239 formed in the printed circuit board 230 and then is adapted to mate with the contacts formed on the underside (lower surface 238) of the printed circuit board 230. In this manner, all of the electrical connections between the jack component 210 and the printed circuit board 230 and the terminal block 250 and the printed circuit board 230 occur along the lower surface 238. It will be appreciated that the contacts 262 electrically mate with the respective contacts of the printed circuit board and through traces formed across the lower surface 238, the contacts 262 are electrically connected to the contacts of the jack component 210.

The housing 300 is mated to the internal sub-assembly 200 to form the connector assembly 100. In the illustrated embodiment, the housing 300 is formed using an injection molding process and in particular, the housing 300 is formed by an “overmolding” technique in which the assembled sub-assembly 200 is placed into a mold and then a plastic material is injected into the mold so as to form the housing 300 around the sub-assembly 200. In this manner, the sub-assembly 200 is securely held in a fixed location within the housing 300. Other techniques can be used to mate the two together. For example, the housing 300 can be formed of two pieces that mate together after the insertion of the sub-assembly 200 into one or more of the pieces.

The housing 300 is a substantially hollow member that includes a first end 302 and an opposing second end 304. The housing 300 can be thought to have a first end portion 310 that is configured to complement the jack component 210 and a second end portion 320 that is configured to complement the terminal block 250. The housing 300 is preferably formed of a plastic material and each of the end portions 310, 320 is a hollow member. The first end portion 310 and the second end portion 320 can have an annular shape as illustrated; however, other shapes are possible. The first end portion 310 terminates in the first end 302 and the second end portion 320 terminates in the second end 304.

The second end portion 320 has a cut out 312 in that the housing in this portion is not a complete annular housing but instead, is missing an arcuate section where the cut out 312 is formed. The cutout 312 is sized and positioned so that when the housing 300 is formed around the internal sub-assembly 200, a substantial portion of the terminal block 230 is positioned above the edges that define the cutout 312. In other words, the second end portion 320 in the cutout region 312 has a shape that is similar to a semi-circle and it will be appreciated that the width or inner diameter of the second end portion 320 is such that the printed circuit board 230 and the terminal block 250 can be received within the second end portion 320 between the side walls thereof.

The second end portion 320 has a planar support surface or wall 330 on which the second end 234 of the printed circuit board 230 sits and thus, the planar surface 330 supports both a portion of the printed circuit board 230 and the overlying terminal block 250. The hollow portion of the second end portion 320 is defined by a compartment or cavity 313 that is configured to receive and hold a portion of each of the stereo jack component 210 and the printed circuit board 230.

The cavity 313 does not extend all the way to the second end 304 of the housing 300 but instead terminates prior thereto. The cavity 313 thus terminates at a vertical wall 315 that is spaced from the second end 304 of the housing 300. Since the stereo jack component 210 has an annular shape, the cavity 313 has a complementary circular shape at least in a portion thereof. The terminal block 250 is disposed over both the planar surface 330 and the cavity 313.

A shoulder (e.g., vertical wall) 340 is formed between the first end portion 310 and the second end portion 320 and when the housing 300 is formed around the sub-assembly 200, the front face 252 of the terminal block 250 is proximate to or in contact with the shoulder 340. A space or slot is thus formed between the vertical wall 340 and the planar surface 330 and defines an entrance into the cavity 313 (permitting extension of contact 262).

The first end portion 310 is substantially hollow in that it includes a central bore 350 that is open at the first end 302 of the housing 300 and is in communication with the cavity 313.

Since the first end portion 310 is configured to complement not only the stereo jack component 210 but also the printed circuit board 230, the bore 350 is defined by a planar ceiling or upper surface 352 that is configured to interface with the planar, printed circuit board 230. The planar ceiling 352 extends from the vertical wall 340 but terminates in a shoulder 354 prior to the second end 304 of the housing 300. The first end 232 of the printed circuit board 230 is disposed against the shoulder 354 when the housing 300 is formed around the internal sub-assembly 200.

As can be seen in the cross-sectional view of FIG. 6, the first end 212 of the stereo jack component 210 extends slightly beyond the first end 302 of the housing 300. In contrast, the second end 234 of the printed circuit board 230 is preferably flush with the second end 304 of the housing 300.

An outer surface 360 of the second end portion 320 is in the form of a threaded bushing in that it includes a portion having external threads 370. The external threads 370 extend to the first end 302 of the housing 300 and terminate at the opposite end at a shoulder 372 (e.g., vertical wall).

The external threads 370 are not formed around the entire circumference of the second end portion 320 since the mounting form-factor of the connector 100 preferably uses an industry standard form-factor. In particular, the connector 100 employs a “D” punch configuration so that it can be mounted in a “D” punch, which refers to a hole that can be made in a panel and includes one flat side. The outer surface 360 thus has one flat (planar section) 380 that permits the connector 100 to be inserted into a D-punch. In the illustrated embodiment, the connector 100 employs a ½ inch “D” punch meaning that the hole in the panel is ½ inch in diameter and includes a flat side. The flat side of the hole (punch) insures correct orientation as well as prevents the connector 100 from rotating in its mounting.

The connector 100 also includes a fastener, such as a hex nut, 400 that is configured to mate with the housing 300 by threadingly engaging the external threads 370. As shown in FIG. 9, the distance between the hex nut 400 and the shoulder 372 where the threads 370 terminate defines the width of an object (e.g., panel or like) to which the connector 100 is mounted to. FIG. 10 shows the “behind the panel” dimension of the connector 100.

Accordingly, the present invention eliminates the “behind the panel depth” problem because the behind the panel depth is short in contrast to conventional designs and due to the construction of the connector assembly 100 of the present invention. In addition, because the rear termination of the present is in the form of the terminal block 250, the length of the mating connector is no longer a consideration as a mating connector is not necessary with the connector assembly 100. Because of this, the present invention will fit into installations that the “feed-thru” style will not.

Another benefit of the present invention is that the hassle, difficulty, and expense of soldering are removed because the rear termination is in the form of the terminal block 250. Consequently, the only tools needed are a wire stripper and screwdriver, neither of which requires electric power, and both of which are typically included in every common installer's tool kit and can be easily used anywhere.

The challenge faced by standard threaded bushing type connectors with a wall plate, panel, chassis and box wall thicknesses is removed due to the length of the threaded bushing (housing 300) of the connector assembly 100 of the present invention. The length is such that the connector assembly 100 of the present invention can mount into wall plates, panels, chassis and boxes with thicknesses up to ¼ inch (0.250 inch) (as shown in FIG. 9), which is more than two and a half times the capacity of the average threaded bushing type 3.5 mm stereo connector. As shown in FIG. 10, the connector assembly 100 can have a “behind the panel” dimension of about 0.43 inch. The distance from the first end to the second end of the connector assembly 100 (as measure from end 302 to end 304) is about 0.756 inches. The distance from the upper surface 256 of the terminal block 250 to the bottom or lower surface of the plastic housing 300 is about 0.707 inches.

In addition, the mounting form-factor of the connector assembly 100 of the present invention uses an industry standard form factor. As previously mentioned, the connector assembly 100 of the present invention employs a V₂ inch “D” punch and therefore, can easily be used in conventional D punch wall holes.

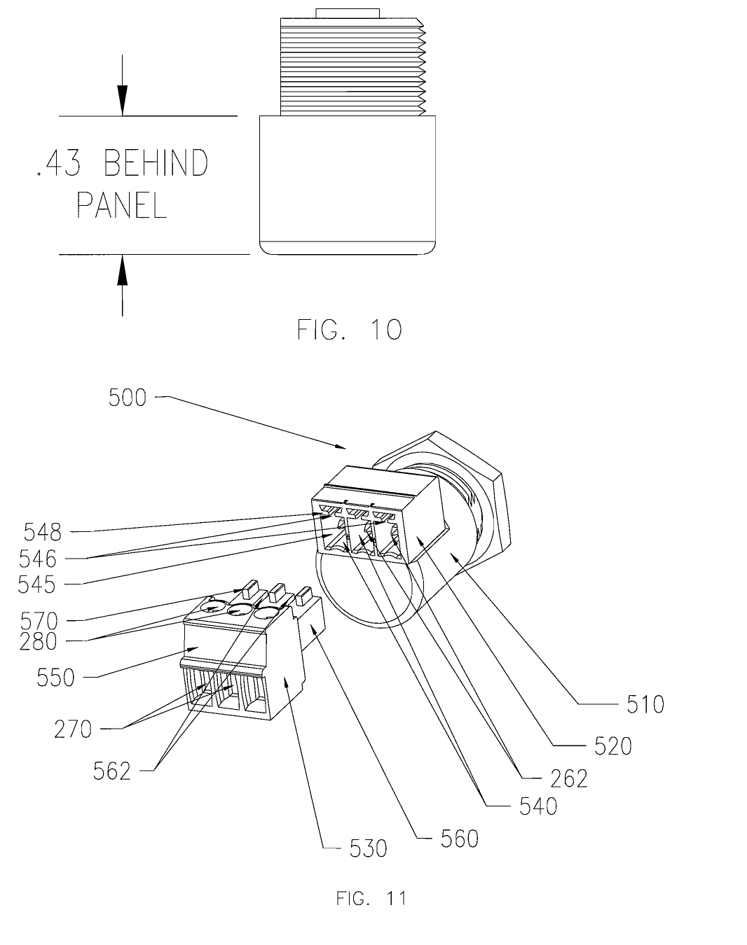

Now referring to FIG. 11 in which a stereo connector assembly 500 is illustrated. The stereo connector assembly 500 is similar to the connector assembly 100 and therefore, like parts are numbered alike. However, in this embodiment, the terminal block is constructed of two separate parts that are detachably coupled (e.g., pluggable) with one another. As shown in FIG. 11, a terminal block assembly 510 forms a part of the connector assembly 100 and includes a first part, namely, a base portion (terminal receptacle) 520 and a second part, namely, a terminal port portion (plug portion) 530 that is detachably coupled to the base portion 520.

The base portion 520 defines the portion that is supported on and secured to the printed circuit board 230 (FIG. 6). The conductive engagement of the base portion 520 to the circuit board 230 can be performed in the same manner in which the terminal block 250 engages the circuit board 230. The base portion 520 includes a number of terminal openings or slots 540 that are formed and are open along it rear edge 522. In the illustrated embodiment, the terminal openings 540 have rectangular shapes. Within each of the terminal openings 540, one contact 262 is provided. As mentioned above, each contact 262 is electrically conducted to a contact that is part of the printed circuit board 230. In the illustrated embodiment, there are three contacts 262.

The base portion 520 also includes locating and coupling means 545 for coupling the terminal port portion (plug portion) 530 to the base portion 520. In particular, the locating and coupling means 545 is in the form of a slot 546 that is formed between two walls or rails 548. Each terminal opening 540 includes one slot 546 formed near a top section thereof. The slot 546 is open along the rear edge of the base portion 520.

The terminal port portion (plug portion) 530 resembles the rear face of the terminal block 250 and includes a first section 550 that includes terminal openings or slots 270 that receive the contacts or conductive members, such as wires, as a means for terminating the wires and electrically connect the wires to another component. The slots 270 are configured so that when the plug portion 530 is mated to the base portion 520, the terminal slots 270 and the terminal openings 540 are in registration to permit the wires to be electrically connected to contacts 262. The first section 550 also includes the fastening means 280 for engaging and holding the wires in place within the slots 270.

The plug portion 530 also includes a second section 560 that acts as a coupling member or plug in that the mating between the second section 560 and the base portion 520 causes the two portions 520, 530 to form a single terminal block. The second section 560 resembles a protrusion or plug that extends outwardly from the first section 550 and is designed to mate with the base portion 520.

The second section 560 is actually formed of a number of different protrusions or plugs that are separated from one another by spaces 562. Each individual plug is intended to be received into one terminal opening 540 and the spaces 562 receive the walls 541 that define the individual terminal openings 540. When the wires are engaged by the fastening means 280, the wires are located within the individual plugs 560 and the plugs 560 are dimensioned so that when they are received into the respective terminal openings 540 of the base portion 520, the contacts 262 are received within the plugs 560 so as to be brought into electrical contact with the wires that are fastened and held in place within the plugs 560. More specifically, each of the plugs 560 includes a “socket-type” contact to which one wire is electrically connected and when the plugs 560 are received within the openings 540, the contacts 262 engage the socket-type contacts, thereby causing the terminated wires to be electrically connected to the contacts 262 and the printed circuit board.

Each plug 560 includes a locator/fastening member 570 that serves to properly locate the plug 560 within the terminal opening 540 and to securely couple the plug portion 530 to the base portion 520. For example, the locator/fastening member 570 can be in the form of a tab or protrusion that is formed along an upper surface of the plug 560. The tab 570 is received within one slot 546 of the respective terminal opening 540. In the illustrated embodiment, each tab 570 has a rectangular shape that is complementary to the shape of the slot 546. The receipt of the tab 570 between the walls (rails) 548 within the slot 546 results in the coupling of the two parts of the terminal block assembly 510. For example, a frictional fit can be formed between the tab 570 and the slot 546 so as to securely attach the plug portion 530 to the base portion 520. In addition, the tab 570 and slot 546 arrangement permits the plug portion 530 to be conveniently slid into and out of engagement with the base portion 520.

The tabs 570 and slots 546 also provide a keying mechanism so that the plug portion 530 cannot be mis-mated with the base portion 520. For example, the plug 530 cannot be rotated 180 degrees and still mate with the base portion 520.

By separating the terminal block assembly 510 into two components, namely, the plug portion 530 and the receptacle or base portion 520, the wires can first be first inserted into the terminal openings 270 and into the hollow interiors of the respective plugs 560 and then secured therein using the fastening members 280. After the wires are securely held in place, the plugs 560 are then inserted into the terminal openings 540 as previously described resulting in the contacts 262 engaging the wires, thereby establishing an electrical connection between the wires and the contacts 262.

It will also be appreciated that other means for coupling the plug portion 530 to the terminal receptacle 520 can be used. For example, a snap-fit connection can be used or some other type of connection.

The remaining components of the assembly 500 are similar to the assembly 100 and therefore, offer the same advantages as the assembly 100.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A stereo jack assembly comprising:
an internal sub-assembly including a printed circuit board, a stereo jack component for receiving a stereo jack plug, and a terminal block, the stereo jack component being disposed against and in electrical contact with a first surface of the printed circuit board, the terminal block being disposed against and in electrical contact with a second surface of the printed circuit board; and
a housing surrounding at least a portion of the internal sub-assembly, the housing having a first portion that has external threads for mating with a fastener that is used to attach the stereo jack assembly to a surface.

2. The assembly of claim 1, wherein the stereo jack component has a hollow interior for receiving the stereo jack plug and includes first fastening members that mate with second fastening members associated with the printed circuit board for coupling the stereo jack component to the printed circuit board.

3. The assembly of claim 2, wherein the first fastening members are projections that are received in openings that comprise the second fastening members in the printed circuit board.

4. The assembly of claim 1, wherein the first surface of the printed circuit board is a lower surface and the second surface of the printed circuit board is an upper surface.

5. The assembly of claim 1, wherein the terminal block comprises a means for connecting a rear of the connector assembly to an electrical component that includes wires that are electrically connected and terminated in the terminal block.

6. The assembly of claim 5, wherein the terminal block includes terminal opening for receiving the wires, the terminal openings being disposed at one end of the housing.

7. The assembly of claim 1, wherein the first portion that includes the external threads includes a flat that permits the stereo jack assembly to have a D-punch form factor.

8. The assembly of claim 1, wherein a length of the first portion with external threads is such that the stereo jack assembly can be mounted to an object having a thickness up to and including 0.250 inches.

9. The assembly of claim 1, wherein the stereo jack assembly has a behind the panel dimension of 0.43 inches or less as measured by a length of a second portion of the housing which extends from a first location where the first and second portions interface and the external threads terminate to an end of the housing opposite where the stereo jack component is disposed.

10. The assembly of claim 1, wherein the stereo jack component is configured to receive a 3.5 mm stereo jack.

11. The assembly of claim 1, wherein the surface is part of a structure selected from the group consisting of a wall plate, panel, chassis and box.

12. A stereo jack assembly comprising:
an internal sub-assembly including a printed circuit board, a stereo jack component for receiving a stereo jack, and a terminal block, the stereo jack component being disposed against and in electrical contact with a first surface of the printed circuit board, the terminal block being disposed against and in electrical contact with a second surface of the printed circuit board, the terminal block including a first part that is supported on the printed circuit board and a second part that is separate from the first part and includes means for receiving and terminating ends of a plurality of first contacts that are to be electrically connected to the circuit board, the first and second parts being coupled to one another; and
a housing surrounding at least a portion of the internal sub-assembly, the housing having a first portion that has external threads for mating with a fastener that is used to attach the stereo jack assembly to a surface.

13. The assembly of claim 12, wherein the first part of the terminal block includes first terminal openings with each first terminal opening having a first locating and coupling member for attaching the second part of the terminal block to the first part.

14. The assembly of claim 13, wherein the first part of the terminal block further includes a plurality of second contacts that are electrically connected to the circuit board and are electrically connected to the first contacts when the first and second parts of the terminal block mate together.

15. The assembly of claim 14, wherein each first terminal opening includes one first contact and the first locating and coupling member comprises a slot formed between two walls within an interior of the first terminal opening.

16. The assembly of claim 14, wherein the second part of the terminal block includes a plurality of second terminal openings for receiving and terminating the first contacts and a plurality of plug portions that are received within the first terminal openings for electrically connecting the first and second contacts, the plugs including second locating and coupling members for attaching the first and second parts to one another.

17. The assembly of claim 16, wherein the second part of the terminal block includes a means for fixing the first contacts within the plug portions in positions where they are electrically connected to the second contacts when the plugs are inserted into the first terminal openings of the first part.

18. The assembly of claim 16, wherein the second locating and coupling members comprise tabs formed along exterior surfaces of the plugs, the tabs being received within slots that are formed within the first terminal openings and define the first location and coupling members so as to couple the first and second parts together to form the terminal block.
